(19) United States
(12) Patent Application Publication
(10) Pub. No.: US 2017/0193456 A1
(43) Pub. Date: Jul. 6, 2017

(54) ELECTRONIC DEVICE AND CALENDARING METHOD THEREOF

(71) Applicant: HTC CORPORATION, TAOYUAN CITY (TW)

(72) Inventor: Pei-Ju LEE, Taoyuan City (TW)

(21) Appl. No.: 14/989,317

(22) Filed: Jan. 6, 2016

(51) Int. Cl. G06Q 10/10; H04L 29/08

(52) U.S. Cl. CPC G06Q 10/1095; H04L 67/26

(57) ABSTRACT

An electronic device and a calendaring method thereof are provided. The electronic device comprises a transceiver, a display screen, an input unit and a processor, wherein the processor electrically connected with the transceiver, the display screen and the input unit. The transceiver receives an activity event from a server, wherein the activity event contains an activity time and an activity content. The display screen displays the activity event and a button on a user interface of an activity application. The input unit receives an input event corresponding to the button. The processor calendars the activity event into a date of a calendar application corresponding to the activity time.

### BACKGROUND OF THE INVENTION

Field of the Invention

The present invention relates to an electronic device and a calendaring method thereof; and more particularly, the present invention relates to a electronic device and a calendaring method thereof for calendaring an activity event into the calendar application.

Descriptions of the Related Art

Calendar applications are the basic applications in electronic devices (e.g., smart phones, tablet computers and notebook computers) used by the general consumers. In a conventional calendaring method, when a user would like to add any new activity event into a calendar application, he or she has to key in the related information word by word.

If the user use the calendar application very often, and always has to key in a lot of information of activity events, and the aforementioned conventional calendaring method will cause inconvenience to the user.

Accordingly, an urgent need exists in the art to provide a solution of calendaring activity events into calendar applications more convenient in use.

### SUMMARY OF THE INVENTION

The present invention provides an electronic device and a calendaring method to calendar an activity event into a calendar application.

The electronic device of the present invention comprises a transceiver, a display screen, an input unit and a processor, wherein the processor electrically connected with the transceiver, the display screen and the input unit. The transceiver receives an activity event from a server, wherein the activity event contains an activity time and an activity content. The display screen displays the activity event and a button on a user interface of an activity application. The input unit receives an input event corresponding to the button. The processor calendars the activity event into a date of a calendar application corresponding to the activity time.

The calendaring method of the present invention is for use in the aforesaid electronic device, and the electronic device comprises a transceiver, a display screen, an input unit and a processor, wherein the processor electrically connected with the transceiver, the display screen and the input unit. The calendaring method comprises: (a) receiving an activity event from a server by the transceiver, wherein the activity event contains an activity time and an activity content; (b) displaying the activity event and a button on a user interface of an activity application by the display screen; (c) receiving an input event corresponding to the button by the input unit; and (d) calendaring the activity event into a date of a calendar application corresponding to the activity time by the processor.

As can be known from the above description, the electronic device and the calendaring method thereof of the present invention calendar the activity event into the calendar application. Under the present invention, the user does not have to key in a new activity event into the calendar application word by word. With the present invention, the user can use the calendar application more conveniently.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts a functional block diagram of an electronic device according to a first embodiment of the present invention;

FIG. 1B depicts a functional block diagram of another electronic device according to the first embodiment of the present invention;

FIG. 2 depicts a user interface of an activity application according to the first embodiment of the present invention;

FIG. 3 depicts a user interface of an activity application according to the first embodiment of the present invention;

FIG. 4 depicts a display of a push notification corresponding to the activity event according to a second embodiment of the present invention; and

FIG. 5 depicts a flowchart diagram of a calendaring method according to a third embodiment of the present invention.

### DESCRIPTION OF THE PREFERRED EMBODIMENT

In the following descriptions, a electronic device and a calendaring method thereof of the present invention will be explained with reference to embodiments thereof. However, these embodiments are not intended to limit the present invention to any environments, applications or implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

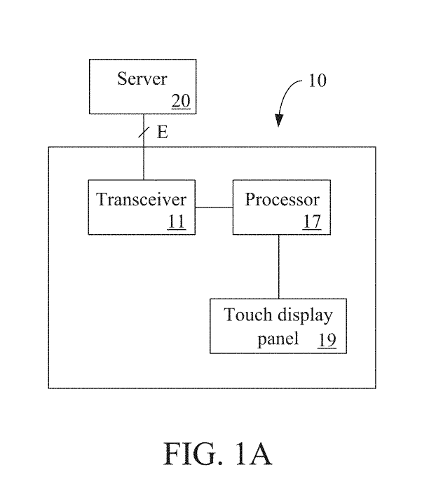

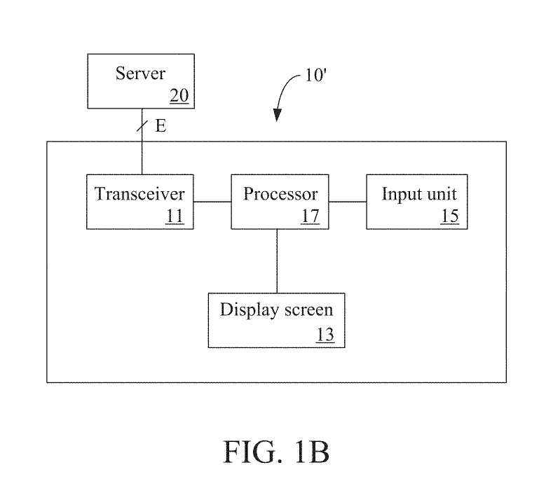

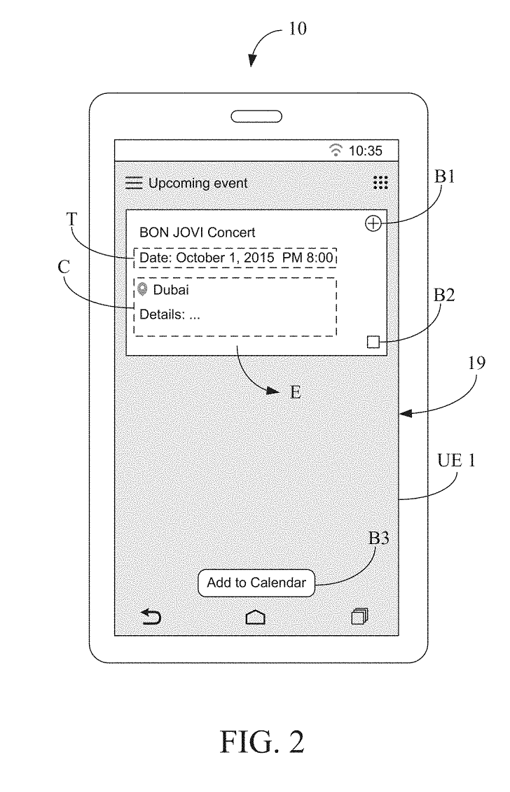

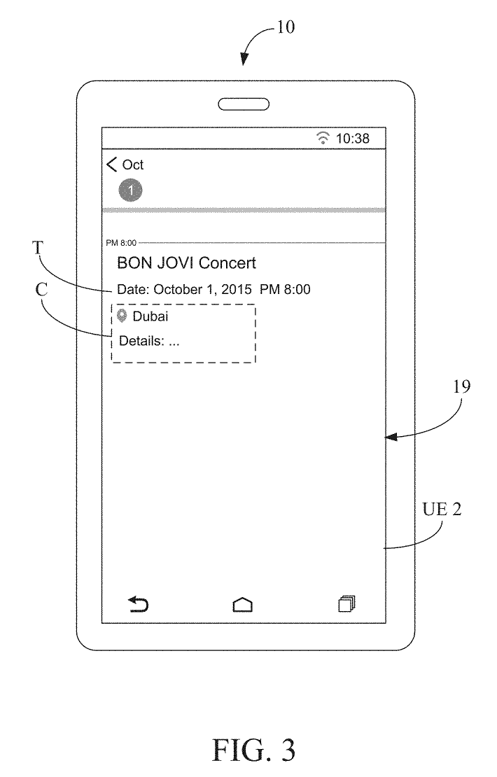

An electronic device according to a first embodiment of the present invention is shown in FIG. 1A, FIG. 1B, FIG. 2 and FIG. 3. FIG. 1A and FIG. 1B depict a functional block diagram of the electronic device 10 and the electronic device 10′ respectively, FIG. 2 depicts an activity user interface UE1 of an activity application of the electronic device 10, and FIG. 3 depicts a calendar user interface UE2 of a calendar application of the electronic device 10.

In FIG. 1A, the electronic device 10, for example, may be a smartphone or any electronic device which has a touch display panel, comprises a transceiver 11, processor 17 and the touch display panel 19. The processor 17 is electrically connected with the transceiver 11 and the touch display panel 19. The transceiver 11 communicates with a server 20 via a wireless network or a wired network. The transceiver 11 receives an activity event E from the server 20, the activity event E contains an activity time T and an activity content C.

As shown in FIG. 2, when the user open an activity application in the electronic device 10, the touch display panel 19 displays the activity user interface UE1 of the activity application, and at least one activity events will be displayed on the activity user interface UE1. Those of ordinary skill in the art can readily appreciate that one activity event or more activity events can be displayed on the activity user interface UE1.

In this embodiment, the activity event E and a first button B1 are displayed on the activity user interface UE1. If the user would like to add the activity event E into a calendar application of the electronic device 10, the user presses the first button B1, and the touch display panel 19 receives an input event corresponding to the first button B1. The input event corresponds to the user's input command (e.g. touch) on the touch display panel 19.

For another implement way, the user can click the select block B2 firstly and press the second button B3 on the activity user interface UE1 to replace the foregoing action of pressing the first buttom B1.

Then, the processor 17 calendars the activity event E into a date of a calendar application corresponding to the activity time T according to the input event automatically.

Afterwards, the user may open the calendar application of the electronic device 10 and clicks the date, and the activity content and/or the activity time will be displayed on the calendar user interface UE 2 as shown in FIG. 3.

In reference to FIG. 1B, the electronic device 10′ may be a desktop computer, a laptop computer or any electronic device having separated display screen and input unit. The electronic device 10′ comprises a transceiver 11, a display screen 13, an input unit 15 and a processor 17. The processor 17 is electrically connected with the transceiver 11, the display screen 13 and the input unit 15.

In this embodiment, the functions of the display screen 13 and the input unit 15 of the electronic device 10′ may replace the functions of the touch display panel 19 of the electronic device 10. The display screen 13 is a monitor or the like. The input unit 15 is a parallel port, serial port, USB or the like and is electronically connected with a peripheral such as keyboards, mice or the like.

Those of ordinary skill in the art can readily appreciate that how the display screen 13 of the electronic device 10′ displays the activity event E, the activity time T, the activity content C, the first button B1, the select block B2, the second button B3, the activity user interface UE1 and the calendar user interface UE 2, and how the input unit 15 of the electronic device 10′ receives the input event corresponding to the first button B1 or the second button B3. The input event corresponds to the user's input command via the input unit 15.

Furthermore, the server 20 may be a large ticketing center server, the activity event E is sent from the large ticketing center server directly and received by the transceiver 11.

Or, the server 20 may be an activity server, and the activity event E is sent from the activity server and received by the transceiver 11. The activity event E may be registered to the activity server and verified by an adminstrator of the activity server.

In addition, the touch display panel 19 of the electronic device 10 and the display screen 13 of the electronic device 10′ may display a countdown information based on the activity time T of the activity event E on the activity user interface UE1.

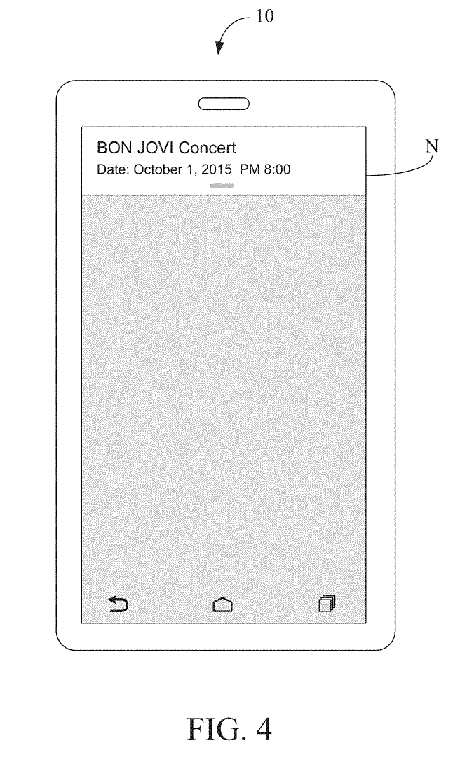

Furthermore, the processor 17 may further generate a push notification corresponding to the activity event, and this will be described with reference to a second embodiment. Refer to FIG. 1A, FIG. 1B and FIG. 4 for the second embodiment of the present invention, FIG. 4 depicts a display of the push notification corresponding to the activity event.

The electronic devices 10 and 10′ of the second embodiment comprises the same elements as the electronic devices 10 and 10′ of the first embodiment, and can execute all the operations that can be executed by the electronic devices 10 and 10′ of the first embodiment, so the following description will focus on differences therebetween.

In one embodiment, the activity content further contains an activity location. When the user changes a present location of the electronic device 10 or 10′, the processor 17 determines that the activity location corresponds to a present location of the electronic device 10 or 10′, then the processor 17 generates a push notification N corresponding to the activity event E. In addition, the processor 17 may determine that the activity location corresponds to a present location of the electronic device 10 or 10′ and the activity time is within the next three days, then generates the push notification N.

In another embodiment, the activity content contains the activity location, the processor 17 further captures a plan which contains a plan duration and a plan location from at least one of the calendar application, an e-mail application and another application of the electronic device 10 or 10′. Afterwards, the processor 17 determines that the activity time T and the activity location correspond to the plan duration and the plan location respectively, then the processor 17 generates the push notification N corresponding to the activity event E.

In another embodiment, the activity application has a preset first activity classification and a preset second activity classification, the first activity classification and the second activity classification both have a plurality of other activity events, and the activity event E belongs to the first activity classification. The processor 17 may generate the push notification N according to a determination made by the processor 17. The determination is that a use frequency of the plurality of other activity events of the first activity classification is higher than a use frequency of the plurality of other activity events of the second activity classification in the last three months or a long duration. Or, the determination is that the use frequency of the plurality of other activity events of the first activity classification is higher than a threshold.

After generating the push notification N, the touch display panel 19 of the electronic device 10 displays the push notification N as shown in FIG. 4. Also, those of ordinary skill in the art can readily appreciate that how the display screen 13 of the electronic device 10′ displays the push notification N.

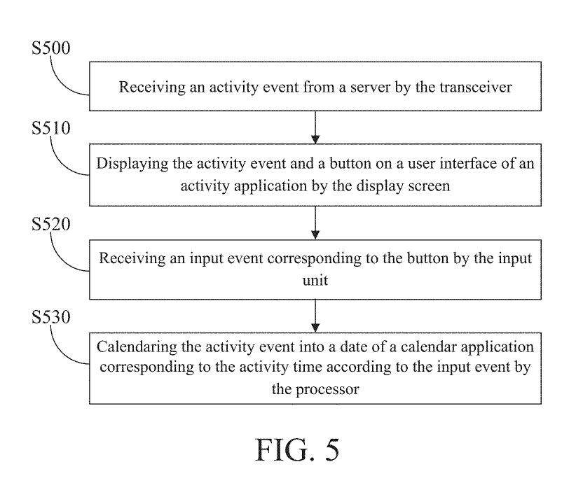

A third embodiment of the present invention is a calendaring method, a flowchart diagram of which is depicted in FIG. 5. The calendaring method is for use in an electronic device (e.g., the electronic devices 10 and 10′ of the first embodiment).

The electronic device, is a desktop computer, a laptop computer or any electronic device having separated display screen and input unit. The electronic device comprises a transceiver, a display screen, an input unit and a processor. The processor is electrically connected with the transceiver, the display screen and the input unit.

The display screen is a monitor or the like. The input unit is a parallel port, serial port, USB or the like and is electronically connected with a peripheral such as keyboards, mice or the like. The transceiver communicates with a server via a wireless network or a wired network.

The calendaring method is executed by the following steps. Firstly, step S500 is executed to receive an activity event from the server by the transceiver. Wherein, the activity event contains an activity time and an activity content.

Then, step S510 is executed to display the activity event and a button on a user interface of an activity application by the display screen. Step S520 is executed to receive an input event corresponding to the button by the input unit. Wherein, the input event corresponds to the user's input command via the input unit.

Step S530 is executed to calendar the activity event into a date of a calendar application corresponding to the activity time according to the input event by the processor.

Afterwards, when the user open the calendar application of the electronic device and clicks the date, the activity content and/or the activity time will be displayed on a calendar user interface of the calendar application.

In another embodiment, the display screen and the input unit may be integrated to a touch display panel. Those of ordinary skill in the art can readily appreciate that how the touch display panel displays the activity event, the button, the activity user interface and the calendar user interface, and how the touch display panel receives the input event corresponding to the button. Wherein, the input event corresponds to the user's input command via the touch display panel.

The server may be a large ticketing center server, the activity event is sent from the large ticketing center server directly and received by the transceiver.

The server may be an activity server, and the activity event is sent from the activity server and received by the transceiver. The activity event may be registered to the activity server and verified by an adminstrator of the activity server.

In addition, the touch display panel or the display screen may display a countdown information based on the activity time of the activity event on the activity user interface.

In addition to the aforesaid steps, the calendaring method of the third embodiment can also execute all the operations and functions of the electronic device set forth in the first embodiment. How the calendaring method of the third embodiment executes these operations and functions can be readily appreciated by those of ordinary skill in the art based on the explanation of the first embodiment, and thus will not be further described herein.

Furthermore, the calendaring method may further comprise a step of generating a push notification corresponding to the activity event by the processor, and this will be described with reference to a fourth embodiment.

In the fourth embodiment, there are three methods to generate a push notification. For the first method, the activity content further contains an activity location. When the user changes a present location of the electronic device, the processor determines that the activity location corresponds to a present location of the electronic device, then the processor generates a push notification corresponding to the activity event. In addition, the processor may determine that the activity location corresponds to a present location of the electronic device and the activity time is within the next three days, then generates the push notification.

For the second method, the activity content contains the activity location, the processor further captures a plan which contains a plan duration and a plan location from at least one of the calendar application, an e-mail application and another application of the electronic device. Afterwards, the processor determines that the activity time and the activity location correspond to the plan duration and the plan location respectively, then the processor generates the push notification corresponding to the activity event.

For the third method, the activity application has a preset first activity classification and a preset second activity classification, the first activity classification and the second activity classification both have a plurality of other activity events, and the activity event belongs to the first activity classification. The processor may generate the push notification according to a determination made by the processor. The determination is that a use frequency of the plurality of other activity events of the first activity classification is higher than a use frequency of the plurality of other activity events of the second activity classification in the last three months or a long duration. Or, the determination is that the use frequency of the plurality of other activity events of the first activity classification is higher than a threshold.

After generating the push notification, the calendaring method further comprises the step of displaying the push notification by the display screen or the touch display panel of the electronic device.

In addition to the aforesaid steps, the calendaring method of the fourth embodiment can also execute all the operations and functions of the electronic device set forth in the second embodiment. How the calendaring method of the fourth embodiment executes these operations and functions can be readily appreciated by those of ordinary skill in the art based on the explanation of the second embodiment, and thus will not be further described herein.

As can be known from the description of the aforesaid embodiments, the present invention can calendar an activity event into the calendar application from the activity application automatically. With the present invention, the user can use the calendar application more conveniently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device, comprising:
a transceiver, being configured to receive an activity event from a server, wherein the activity event contains an activity time and an activity content;
a display screen, being configured to display the activity event and a button on a user interface of an activity application;
an input unit, being configured to receive an input event corresponding to the button; and
a processor electrically connected with the transceiver, the display screen and the input unit, being configured to calendar the activity event into a date of a calendar application corresponding to the activity time.

2. The electronic device as claimed in claim 1, wherein the display screen and the input unit are integrated to a touch display panel.

3. The electronic device as claimed in claim 2, wherein the activity content further contains an activity location, the processor determines that the activity location corresponds to a present location of the electronic device, then the processor generates a push notification corresponding to the activity event, and the touch display panel displays the push notification.

4. The electronic device as claimed in claim 2, wherein the activity content further contains an activity location, the processor further captures a plan which contains a plan duration and a plan location from at least one of the calendar application and another application of the electronic device, and the processor determines that the activity time and the activity location correspond to the plan duration and the plan location respectively, then the processor generates a push notification corresponding to the activity event, and the touch display panel displays the push notification.

5. The electronic device as claimed in claim 2, wherein the activity event belongs to an activity classification, the processor generates a push notification according to a use frequency of a plurality of other activity events of the activity classification, and the touch display panel displays the push notification.

6. The electronic device as claimed in claim 2, wherein the touch display panel further displays a countdown information based on the activity time of the activity event on the user interface.

7. The electronic device as claimed in claim 1, wherein the server is a large ticketing center server.

8. The electronic device as claimed in claim 1, wherein the server is an activity server, and the activity event is registered to the activity server and is verified by an adminstrator of the activity server.

9. The electronic device as claimed in claim 1, wherein the activity content further contains an activity location, the processor determines that the activity location corresponds to a present location of the electronic device, then the processor generates a push notification corresponding to the activity event, and the display screen displays the push notification.

10. The electronic device as claimed in claim 1, wherein the activity content further contains an activity location, the processor further captures a plan which contains a plan duration and a plan location from at least one of the calendar application and another application of the electronic device, the processor determines that the activity time and the activity location correspond to the plan duration and the plan location respectively, then the processor generates a push notification corresponding to the activity event, and the display screen displays the push notification.

11. The electronic device as claimed in claim 1, wherein the activity event belongs to an activity classification, the processor generates a push notification according to a use frequency of a plurality of other activity events of the activity classification, and the display screen displays the push notification.

12. The electronic device as claimed in claim 1, wherein the display screen further displays a countdown information based on the activity time of the activity event on the user interface.

13. A calendaring method for use in a electronic device, the electronic device comprising a transceiver, a display screen, an input unit and a processor electrically connected to the transceiver, the display screen and the input unit, the calendaring method comprising the following steps of:
(a) receiving an activity event from a server by the transceiver, wherein the activity event contains an activity time and an activity content;
(b) displaying the activity event and a button on a user interface of an activity application by the display screen;
(c) receiving an input event corresponding to the button by the input unit; and
(d) calendaring the activity event into a date of a calendar application corresponding to the activity time by the processor.

14. The calendaring method as claimed in claim 13, wherein the display screen and the input unit are integrated to a touch display panel.

15. The calendaring method as claimed in claim 13, wherein the server is a large ticketing center server.

16. The calendaring method as claimed in claim 13, wherein the server is an activity server, and the activity event is registered to the activity server and is verified by an adminstrator of the activity server.

17. The calendaring method as claimed in claim 13, wherein the activity content contains an activity location, and the calendaring method further comprising the following steps of:
(e) determining that the activity location corresponds to a present location of the electronic device by the processor;
(f) generating a push notification corresponding to the activity event by the processor; and
(g) displaying the push notification by the display screen.

18. The calendaring method as claimed in claim 13, wherein the activity content contains an activity location, and the calendaring method further comprising the following steps of:
(e1) capturing a plan which contains a plan duration and a plan location from at least one of the calendar application and another application of the electronic device by the processor;
(f1) determining that the activity time and the activity location correspond to the plan duration and the plan location respectively by the processor;
(g1) generating a push notification corresponding to the activity event by the processor; and
(h1) displaying the push notification by the display screen.

19. The calendaring method as claimed in claim 13, wherein the activity event belongs to an activity classification, the calendaring methods further comprising the following steps of:
(e2) generating a push notification according to a use frequency of a plurality of other activity events of the activity classification by the processor; and
(f2) displaying the push notification by the display screen.

20. The calendaring method as claimed in claim 13, further comprising the steps of: displaying a countdown information based on the activity time of the activity event on the user interface by the display screen.
